(19) United States
(12) Patent Application Publication
(10) Pub. No.: US 2011/0013870 A1
(43) Pub. Date: Jan. 20, 2011

(54) COUPLING DEVICE FOR OPTICAL FIBRES

(75) Inventors: Cornel Marxer, Neuchatel (CH); Peter Herbst, Chaumont (CH)

Correspondence Address: MORRISS OBRYANT COMPAGNI, P.C., 734 EAST 200 SOUTH, SALT LAKE CITY, UT, 84102, US

(73) Assignee: SERCALO MICROTECHNOLOGY LIMITED, Schaan (LI)

(21) Appl. No.: 12/836,384

(22) Filed: Jul. 14, 2010

(30) Foreign Application Priority Data
Jul. 14, 2009 (EP) 09 165 438.4

(51) Int. Cl. G02B 6/38; B32B 38/00

(52) U.S. Cl. 385/65; 216/58; 156/60

(57) ABSTRACT

A coupling device (1, 2) for optical fibres (19) comprises a first sheet (11) equipped with a plurality of through-holes (13), of which a portion 13a, at least, has a diameter adjusted to the diameter of said optical fibres (19), and a second sheet (12) joined to said first sheet (11) by a face. Said device (1, 2) also comprises a third sheet (15), joined to said first sheet (11), and equipped with a plurality of through-holes (16), of which a portion (16a), at least, has a diameter adjusted to the diameter of said optical fibres (19), aligned relative to the holes (13) of said first sheet (11), so as to form recesses (18, 25) with which said optical fibres (19) are engaged.

### CROSS-REFERENCE TO RELATED APPLICATION

This application claims priority to European Patent Application No. 09 165 438.4 filed with the European Patent Office on Jul. 14, 2009, the entirety of which is incorporated by this reference.

### BACKGROUND OF THE INVENTION

1. Field of the Invention

The present invention relates to the field of optical fibres. It concerns more particularly a bidimensional device for coupling a bundle of optical fibres.

2. State of the Art

Coupling devices of this type are known to the person skilled in the art. They are intended for transmitting a light signal between one bundle of optical fibres and another bundle of optical fibres, or one or more, active or passive, optical or optoelectronic components such as connectors, light emitting or laser diodes, etc.

In order to minimise signal losses at the input or at the output of the optical fibres caused by optical misalignment, by retroreflection or another optogeometrical effect, the coupling device has to precisely align the axis of the optical fibres and avoid refractive index discontinuity at the interface between the core of the optical fibre and the external environment. The coupling device has, accordingly, a mechanical function of positioning and fixing the optical fibres and an optical function of continuity of the index of refraction. Moreover, the overall size of the coupling device must be as small as possible for obvious practical reasons and in order to comply with the increasing miniaturisation of optoelectronic devices.

Document U.S. Pat. No. 6,328,482 discloses a coupling device meeting these various requirements. Said device is formed by a first sheet made of silicon intended for positioning and for fixing a plurality of optical fibres in a plane and by a second sheet which is made of borosilicate glass and joined to the first by a face. The first sheet comprises a bidimensional network of through-holes, having a diameter adjusted to the diameter of the optical fibres. Typically, the diameter of the holes is of the order of 127 micrometres for a diameter of the optical fibres of 125±0.5 micrometres. The second sheet is equipped with a bidimensional network of lenses on its free face, the lenses being aligned with the holes. The compactness of the device is imparted by the bidimensional character of the coupling device.

The networks of holes and lenses are produced by processes well known to the person skilled in the art, of photolithography and reactive ion etching. The two sheets are aligned relative to each other with the aid of alignment structures etched at the same time as the holes and the lenses, then joined together by anode welding. The optical fibres are then engaged with the holes until their bevelled end enters into contact with the second sheet. The residual space around the fibre is filled up with an optical glue having an index of refraction close to that of the core of the fibre.

The device thus described ensures the positioning of the fibre owing to the hole, and the fixing thereof and also the refractive index continuity, with the aid of the glue.

The precision of the positioning of the fibre is provided by the maximum angle formed between the axis of the fibre and the normal to the second sheet. This angle is dependent on the height of the hole, on its diameter and on the error on the diameter. As mentioned hereinbefore, the diameter of the hole is 127 micrometres and the thickness of a sheet of silicon is typically 400 or 625 micrometres. With these values, it would appear that the precision of the positioning of the fibre in the device according to the prior art is, at best, 0.2 degrees. This value is satisfactory, but in practice, given the limits imposed by reactive ion etching techniques, it is unachievable. That is to say, a hole having a constant diameter of 127 micrometres can be formed only over a thickness of about 50 micrometres. Beyond that, the hole is flared and its lateral dimensions are not preserved. The useful height of the hole is then just 50 micrometres. As a result, the precision of axial positioning of the fibre according to the prior art is closer to 3! This precision is wholly insufficient.

The low useful height of the hole relative to the diameter of the fibre also produces a second potentially very serious limitation: The small gluing surface area gives rise to low resistance to the lateral stresses which can be exerted on the fibre during or after gluing, for example during handling. Thus, a lateral force applied, for example, at 1 centimetre from the gluing point of the fibre exerts, at this point, a shear stress higher than that withstood by the best optical glue! This weakness relative to lateral forces is amplified when use is made of fibres preassembled in a ferrule, of the sort of a metal, resin or ceramic tube intended to mechanically protect the fibre. A ferrule has a diameter of typically 1.25 mm; thus, the ratio between the diameter of the parts to be positioned and the useful height of the hole becomes even more disadvantageous.

Moreover, it will be noted that the use of optical glue for the double function of fixing the fibre and of continuity of the index of refraction can potentially cause signal losses. That is to say, the coefficient of thermal expansion of the silicon, which forms the first sheet, and of the borosilicate glass, which forms the second sheet, is 3.5 μm.deg⁻¹.m⁻¹. This same coefficient has a value of 0.5 μm.deg⁻¹.m⁻¹ for the quartz forming the cladding of the optical fibre. Such a difference of coefficients of thermal expansion generates major stresses on the glue in the case of variations in temperature. Over time, these stresses can cause delamination of the optical fibre and rupture of the index of refraction at the interface between the core of the fibre and the external environment. The signal losses are then considerable.

### SUMMARY OF THE INVENTION

The present invention improves the prior art by providing a bidimensional coupling device for optical fibres that is capable of positioning optical fibres with a precision and a reliability higher than those conventionally obtained.

More particularly, the invention concerns a coupling device for optical fibres comprising a first sheet equipped with a plurality of through-holes, of which a portion, at least, has a diameter adjusted to the diameter of the optical fibres, and a second sheet joined to the first sheet by a face. According to the invention, the coupling device also comprises a third sheet, joined to the first sheet, and equipped with a plurality of through-holes, of which a portion, at least, has a diameter adjusted to the diameter of the optical fibres, aligned relative to the holes of the first sheet, so as to form recesses with which the optical fibres are engaged.

Owing to the third sheet joined to the first sheet, the positioning of the optical fibres, relative to the normal to the second sheet, is improved due to a more favourable ratio of the diameter of the recesses to their height.

In an advantageous embodiment, the device also comprises a spacer, arranged integrally between the first and third sheets, so as to hold them apart and parallel, the recesses then comprising an initial section and a terminal section set apart from each other by the height of the spacer.

Owing to the spacer, the aforementioned ratio is even more favourable, allowing the precision of the positioning of the optical fibre in its recess to be improved still further.

In a particularly advantageous embodiment, the spacer forms a tightly closed volume with the first and third sheets, the optical fibres are fixed in the recesses with the aid of a dose of glue injected into the initial section so as to form, with the optical fibre, a tight-fitting stopper in the initial section and the volume is filled with an optical fluid compound having an index of refraction close to that of the core of the fibre.

Owing to this configuration, the function of fixing the fibre is performed by glue and the function of continuity of the index of refraction is performed by the fluid which can absorb the expansions of the fibres and sheets without being subjected to stress. The device is accordingly exempt from the problem of optical losses due to the delamination of the optical fibre.

### BRIEF DESCRIPTION OF THE DRAWINGS

Other features and advantages of the present invention will become clearer from the following detailed description of an exemplary embodiment of a coupling device according to the invention, this example being given purely for the sake of illustration and merely without limitation and with reference to the appended drawings, in which:

FIGS. 1 and 2 are an exploded perspective and a sectional view respectively of a first embodiment of a coupling device according to the invention, prior to mounting of optical fibres;

FIG. 3 is a sectional view of a variant of this first embodiment;

FIG. 4 is a sectional view of this first embodiment of a coupling device according to the invention, after mounting of optical fibres;

FIG. 5 illustrates the gain in precision of positioning a fibre owing to the first embodiment of a coupling device according to the invention;

FIGS. 6 and 7 are an exploded perspective and a sectional view respectively of a second embodiment of a coupling device according to the invention, prior to mounting of optical fibres;

FIG. 8 is a sectional view of a variant of this second embodiment;

FIGS. 9 and 10 are sectional views of this second embodiment of a coupling device according to the invention, after mounting of optical fibres and ferrules respectively; and

FIG. 11 illustrates the gain in precision of positioning a fibre owing to the second embodiment of a coupling device according to the invention.

### DETAILED DESCRIPTION OF THE ILLUSTRATED EMBODIMENTS

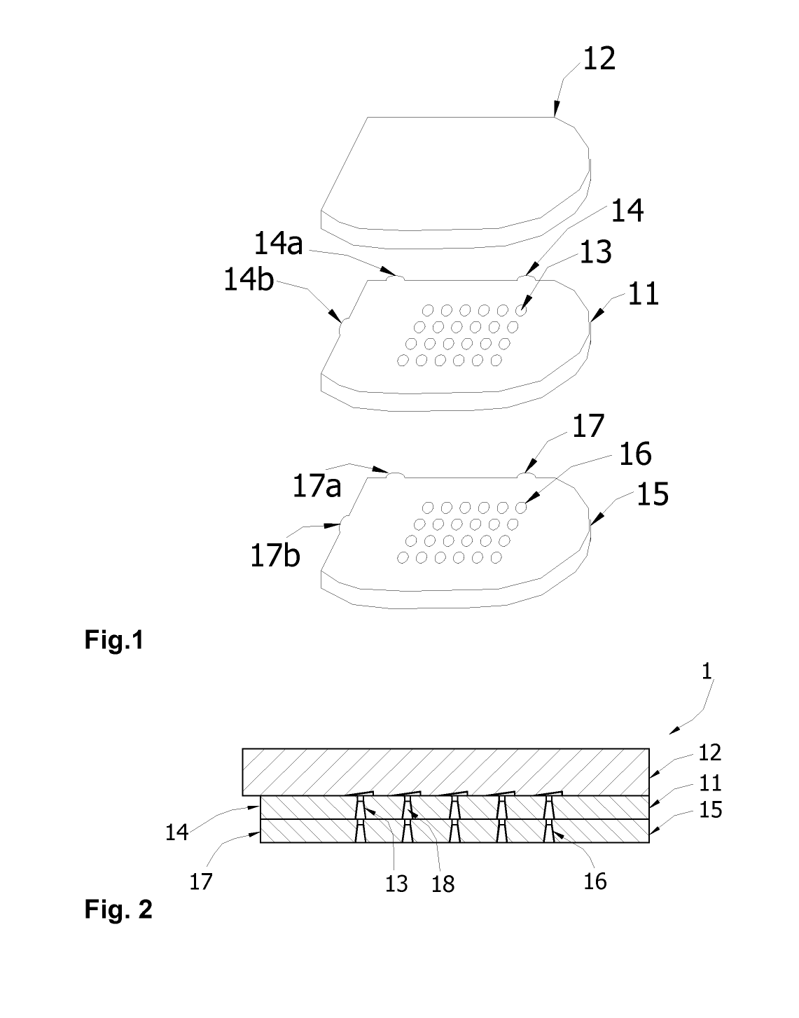

It will be noted first and foremost that throughout FIGS. 1 to 10 the vertical and lateral scales have deliberately not been adhered to for the sake of clarity of the drawings.

The coupling device for optical fibres shown in FIGS. 1 and 2, and denoted in its entirety by reference numeral 1, conventionally comprises a first sheet 11 and a second sheet 12 joined together by a face.

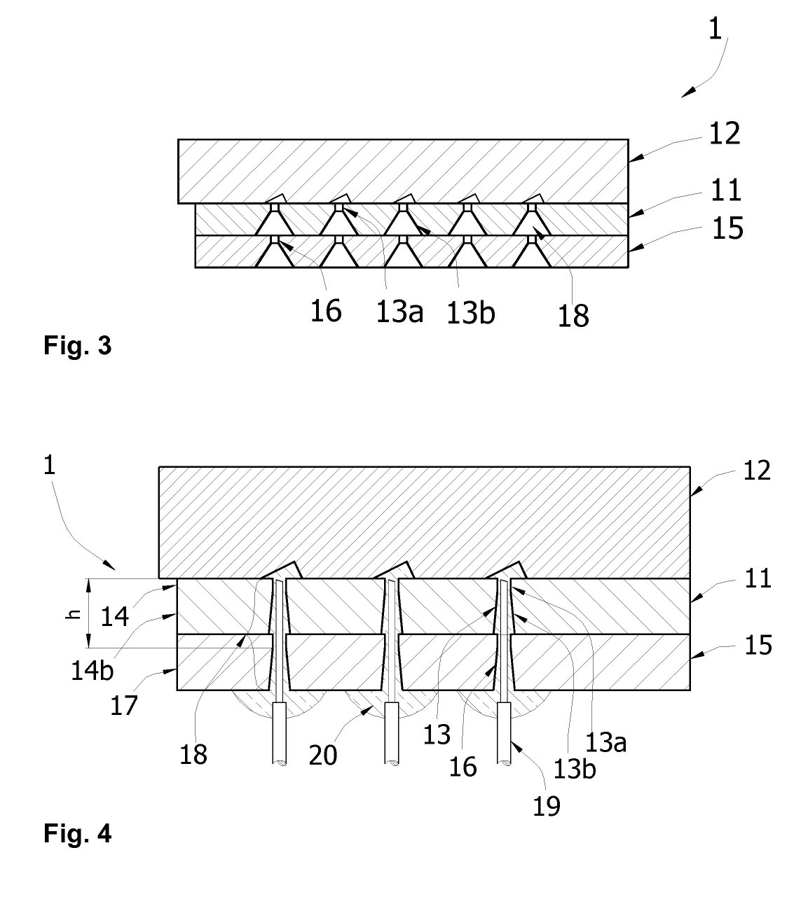

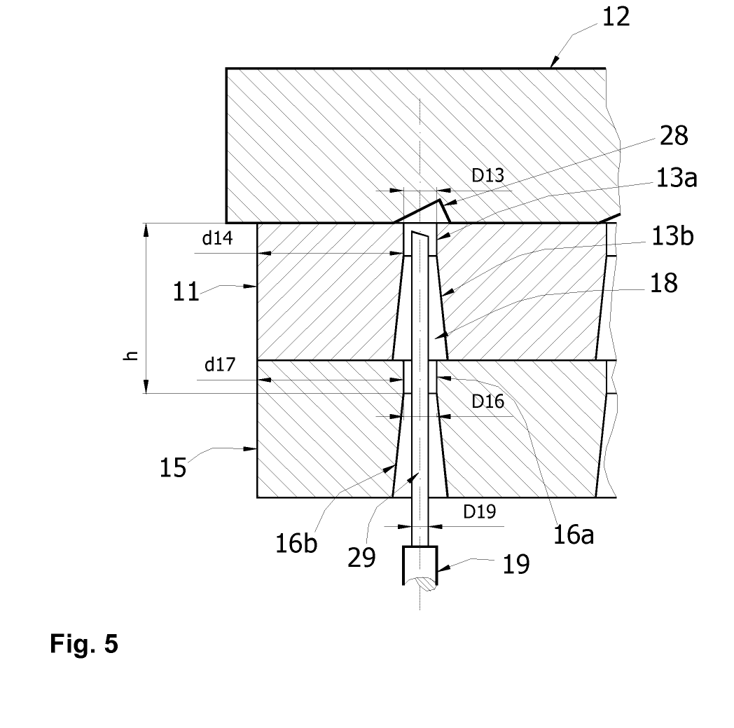

Said first sheet 11 is made of double face-polished, monocrystalline silicon. It comprises a plurality of through-holes 13 aligned in a series of rows and columns. Said holes 13 are formed by photolithography and reactive ion etching techniques well known to the person skilled in the art. They comprise a first portion 13a having a height of about 50 micrometres and a diameter adjusted to the diameter of the optical fibres. This means that the diameter of the portion 13a is larger than that of the optical fibres, so as to be able to forcelessly introduce the fibres into the holes 13, but very close to the manner in which the optical fibres are positioned with precision once internally engaged. The question of the precision of the positioning of the fibres will be addressed in greater detail with reference to FIGS. 5 and 10. At this stage, mention will merely be made of the fact that the diameter of the portions 13a is typically 127 micrometres for a diameter of the optical fibres of 125 micrometres. The holes 13 comprise, furthermore, a second, slightly flared portion 13b having a height of about 575 micrometres. They are formed by reactive ion etching over their entire length, after formation of a resin mask. A process of this type allows the formation of holes 13 as described hereinbefore, comprising a portion 13a having well-defined lateral dimensions and a portion 13b which is slightly flared due to the anisotropic component of the etching. According to a variant shown in FIG. 3, the holes 13 comprise a constant-diameter portion 13a and a highly flared portion 13b. In this scenario, the process for obtaining the holes 13 includes a first reactive ion etching step, intended to etch the constant-diameter portion 13a, and a second wet etching step, intended to etch the highly flared portion 13b. This process, which is well known to the person skilled in the art, necessitates the successive formation on the front face and rear face of two mutually aligned masks. It is more complex but provides a better laterally defined portion 13a than in the case of a constant-diameter hole, as the first mask is less stressed and, in the end, less laterally attacked. In this case, the diameter of the portions 13a reaches 125.5 micrometres with an error of 0.2 micrometres. One or other of these variants is conceivable within the scope of the present invention.

The sheet 11 comprises, furthermore, at least one alignment mark 14 along two axes contained in the plane of the sheet 11, the alignment mark being etched through the sheet 11 concomitantly with the holes 13. In the case presented in FIG. 1, said alignment mark 14 is formed on two sides which are respectively parallel to the columns and rows of holes 13, each equipped with two protuberances 14a and 14b. In a variant, the alignment mark 14 could consist of a cross-shaped hole, of two holes or any other structure allowing an alignment in the plane of the sheet 11. The sheet 11 can also, without prejudice, comprise several alignment marks. Advantageously, the alignment mark 14 is defined in the very same photolithography mask which defines the holes 13.

The second sheet 12 is made of glass, for example of double face-polished, borosilicate glass and does not comprise any structure. In a variant, the sheet 12 can display optical structures such as a network of lenses that is aligned with the network of holes 13. In this case, the sheet 12 comprises an alignment structure which is compatible with the alignment mark 14.

The sheets 11 and 12 are joined together by an anode welding process well known to the person skilled in the art or by any other process imparting high cohesion between the two sheets 11 and 12.

According to the invention, the coupling device 1 also comprises a third sheet 15 which is made of monocrystalline silicon and is joined to the first sheet 11 by a face. Said third sheet 15 is globally identical to the first sheet 11. It comprises a network of holes 16 in rows and columns that is identical to the network of holes 13 that is formed by the same processes and at least one alignment mark 17 which is compatible with the alignment mark 14. Advantageously, the sheets 11 and 15 are structured with the aid of the same photolithography masks.

The sheets 11 and 15 are mechanically aligned relative to each other, in such a way that the holes 13 and the holes 16 are situated in one another's extension and form recesses 18 for optical fibres. For this purpose, use is made of a wedge which is equipped with two reference surfaces and against which the alignment marks 14 and 17 will be positioned in abutment. If the alignment mark consists of one or more, cross-shaped or circular, holes, use is made of one or more suitably shaped reference pins which are engaged with the alignment holes. The alignment can also be carried out by permanently mounting said sheets 11 and 15 in a frame equipped with reference surfaces. Such mechanical alignment against reference surfaces provides an alignment precision of the order of 0.1 micrometres. It will be noted, moreover, that the useful height h of the recesses 18 thus formed is equivalent to one times the thickness of a sheet of silicon plus one times the height of the portion 13a, i.e. 675 micrometres.

The sheets 11 and 15 thus aligned are joined together by anode welding.

Optical fibres 19 are engaged with the recesses 18 formed by the holes 13 and 16, as shown in FIG. 4. Said optical fibres 19 are introduced bare into the recesses 18. In a variant, the optical fibres could be introduced covered by a tube, for example made of plastic, of ceramic or of metal, forming a mechanical protection for the fibre. A configuration of this type comprising an optical fibre enclosed in a protective tube is commonly referred to by the person skilled in the art as a ferrule. Said fibres 19 are introduced into the recesses 18 until they enter into contact with the sheet 12 at their end which is bevelled 29. An optical glue 20 is injected with the aid of a microsyringe through the holes 16 so as to come to fill up the residual volume around the fibres 19 and fix them in the recesses 18. The optical glue 20 has an index of refraction of 1.4, close to that of the core of the optical fibres 19 and of the borosilicate glass forming the sheet 12, so as to preserve the continuity of the index of refraction at the output of the fibres 19.

Owing to the third sheet 15, and to the mechanical alignment thereof relative to the sheet 11, the coupling device according to the invention provides a gain in precision of the alignment of the optical fibre 19 relative to the prior art. Mention will be made of the fact that positioning precision may be expressed as the angle formed between the axis of the optical fibre 19 and the normal N to the sheet 12, the radiation issuing from the fibre 19 having to penetrate the sheet 12, ideally, with an angle of 90°. FIG. 5 shows an optical fibre 19 in its recess 18, and also the various dimensions relative thereto. The diameters D₁₃ and D₁₆ of the portions 13a and 16a, of the holes 13 and 16 respectively, are 125.7 micrometres. The distances d₁₄ and d₁₇ of the holes 13 and 16, from the alignment marks 14 and 17 respectively, display the same error of the order of 0.2 micrometres, being obtained by the same processes. Finally, the mechanical alignment of the two sheets 11 and 15 adds an error of 0.1 micrometres, as mentioned hereinbefore. Now, the error over the distances d₁₄ and d₁₇ and also the error due to the mechanical alignment of the sheets 11 and 15 contribute not directly to the positioning error of the fibre 19 in the recess 18, but solely to the misalignment of the holes 13 and 16. Only the difference between the diameters D₁₃ and D₁₆ of the portions 13a and 16a of the holes 13 and 16, and the diameter of the optical fibres 19, related to the useful height h of the recess 18, contributes to the positioning error. With a difference of diameters having a value of at most 1.4 micrometres, for a useful height h of recess 18 of 675 micrometres, the positioning error relative to the normal N to the sheet 12 is of the order of 0.1°, i.e. about 30 times less than the error according to the prior art!

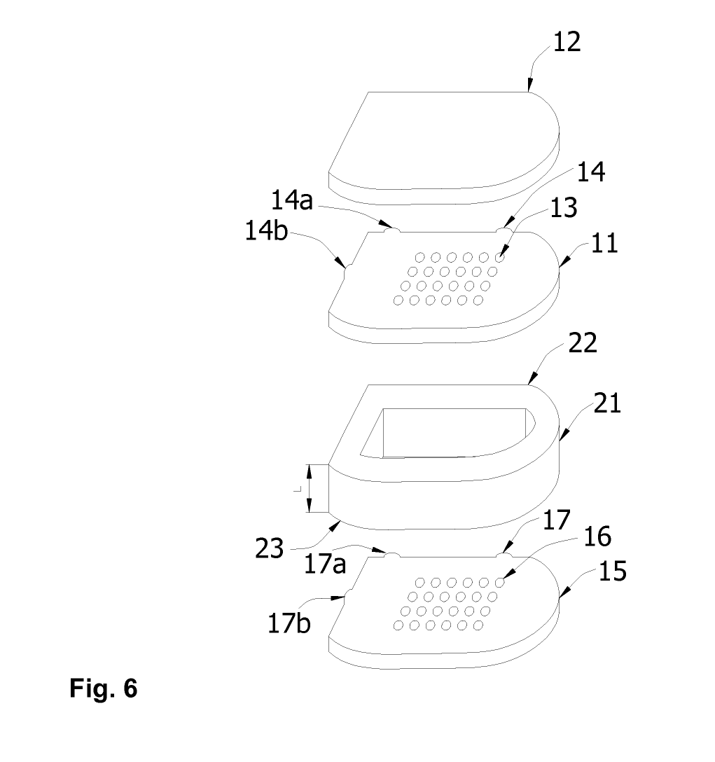

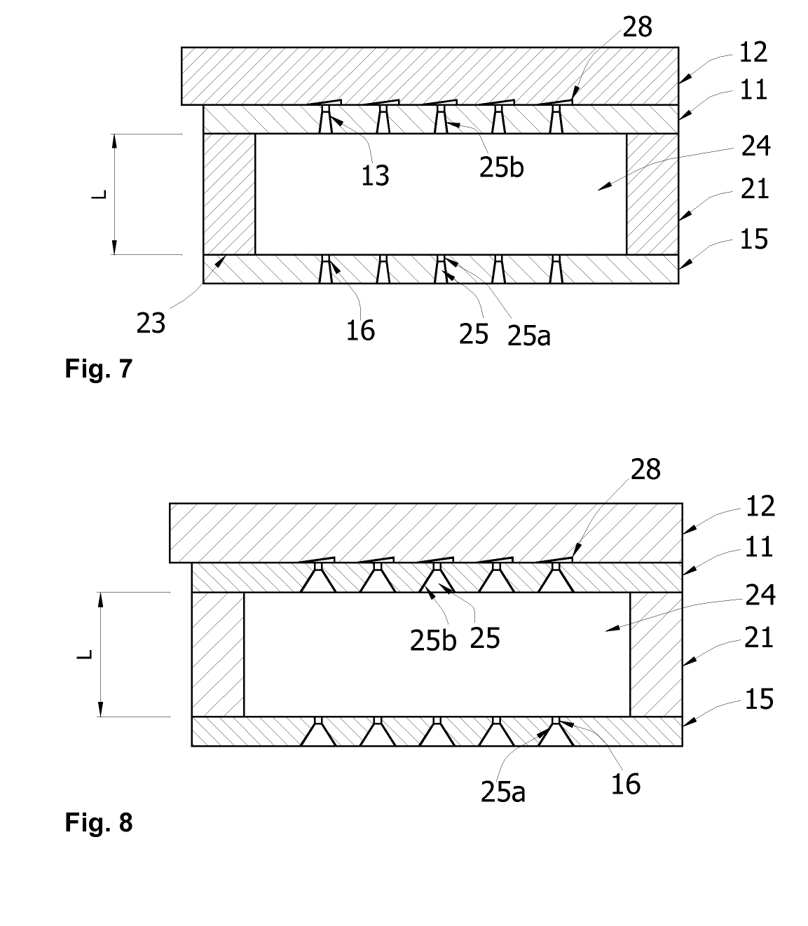

Reference will now be made to FIGS. 6 and 7 which are an exploded perspective and a sectional view respectively of a second embodiment of a coupling device according to the invention. The coupling device for optical fibres shown in FIGS. 6 and 7, and denoted in its entirety by reference numeral 2, is distinguished from the coupling device 1 described hereinbefore in that it comprises, furthermore, a spacer 21 interposed between the sheets 11 and 15. Said spacer 21 is formed by a cylinder portion which is made of borosilicate glass and equipped with an upper face 22 and with a lower face 23, the faces being parallel. Its height L is about 2 millimetres. The spacer 21 is welded to the sheet 11 by its upper face 22 and to the sheet 15 by its lower face 23 so as to hold said joined, remote and parallel sheets 11 and 15. The anode welding is carried out so as to produce a total tightness between the sheets 11 and 15 and the spacer 21. In a variant, the sheets 11 and 15 and the spacer 21 are non-tightly joined. Whatever the mode of welding, the spacer 21 defines, with the sheets 11 and 15, an inner volume 24, the function of which will be described hereinafter.

As for the first embodiment, the sheets 11 and 15 comprise a plurality of holes 13 and 16 respectively. Said holes 13 and 16 are formed either by reactive ion etching alone, as shown in FIGS. 6 and 7, or by a process including a reactive ion etching step and a wet etching step, as shown in FIG. 8. They form recesses 25 for optical fibres, consisting of two sections 25a and 25b, the initial and terminal section respectively, formed by the holes 16 and 13 and set apart from each other by the height L of the spacer 21.

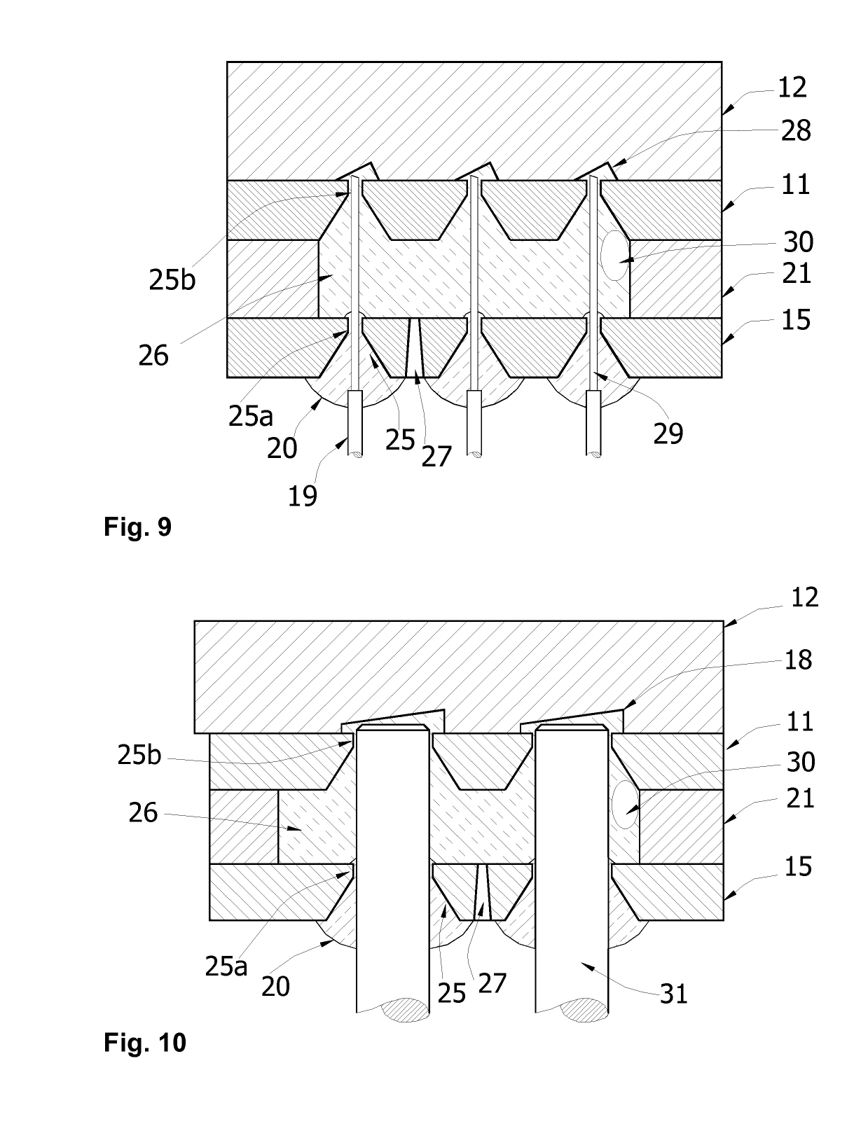

Optical fibres 19 are engaged with the recesses 25 consisting of the holes 13 and 16, as shown in FIG. 9. Said fibres are introduced into the recesses 25 until they enter into contact with the sheet 12 by their end which has a bevelled shape 29. Advantageously, in order to reduce the reflection of light returning into the fibre, the surface of the sheet 12 facing the core of the fibre also has a bevelled shape 28. The introduction of the optical fibres 19 into the recesses 25 does not present any difficulties, as, once engaged with the initial section 25a, they are guided up to the terminal section 25b and penetrate there directly. A small dose of optical glue 20 is injected with the aid of a microsyringe into the initial section 25a of the recesses 25. The dose is calculated to limit the presence of glue 20 at said initial section 25a and ensure that the fibres 19 are fixed solely by this section of the recess 25. The glue 20 also serves to tightly close the inner volume 24 while forming a tight-fitting stopper in the initial section 25a with the fibre 19.

Said volume 24 and also the residual volume around the optical fibres 19 in the terminal sections 25b of the recesses 25 are filled with a fluid optical compound 26 such as an optical gel, an optical oil or another fluid compound having an index of refraction close to that of the core of the optical fibres 19. The optical compound 26 is injected into the volume 24 through a hole 27 which is made in the sheet 15 for this purpose and subsequently reclosed. This operation is carried out under vacuum so as to carefully fill up all of the inner volume 24 and the residual volume around the optical fibres 19. The fluid optical compound 26 is thus accommodated, furthermore, between the end of the optical fibres 19 and the surface 28 of the sheet 12 and ensures the continuity of the index of refraction at the output of the optical fibres 19. It will be noted that, for a fluid optical compound 26 formed by a gel, it is not necessary for the inner volume 24 to be tightly closed by the spacer 21, as the gel remains in place without running or evaporating. An air bubble 30 is added after introduction of the fluid 26 in order to absorb any thermal expansion thereof.

Reference will now be made to FIG. 10 which differs from FIG. 9 in that ferrules 31 are introduced into the recesses 25 instead of the optical fibres 19. The configuration is otherwise identical to the configuration described with reference to FIG. 9, except for the dimensions which have to be adapted to the diameter of the ferrules 31.

It will be noted that, owing to the configuration of the coupling device 2 described hereinbefore, the mechanical function, of fixing the optical fibres 19, and the optical function respectively, of continuity of the index of refraction, are advantageously separate. The first is assured by the initial section 25a of the recess 25 and the glue 20, whereas the second is performed by the terminal section 25b of the recess 25 and the optical fluid 26. This separation is made possible by the presence of the spacer 21 which physically separates the recesses 25 into two distinct sections 25a and 25b which CaO be filled with a fluid independently of each other. The terminal section 25b is thus filled with a fluid optical compound 26, capable of absorbing the expansions or contractions of the coupling device 2 without the delamination effect as observed with an optical glue. The continuity of the index of refraction is then ensured under all circumstances and radiation losses at the output of the optical fibres 19 are avoided.

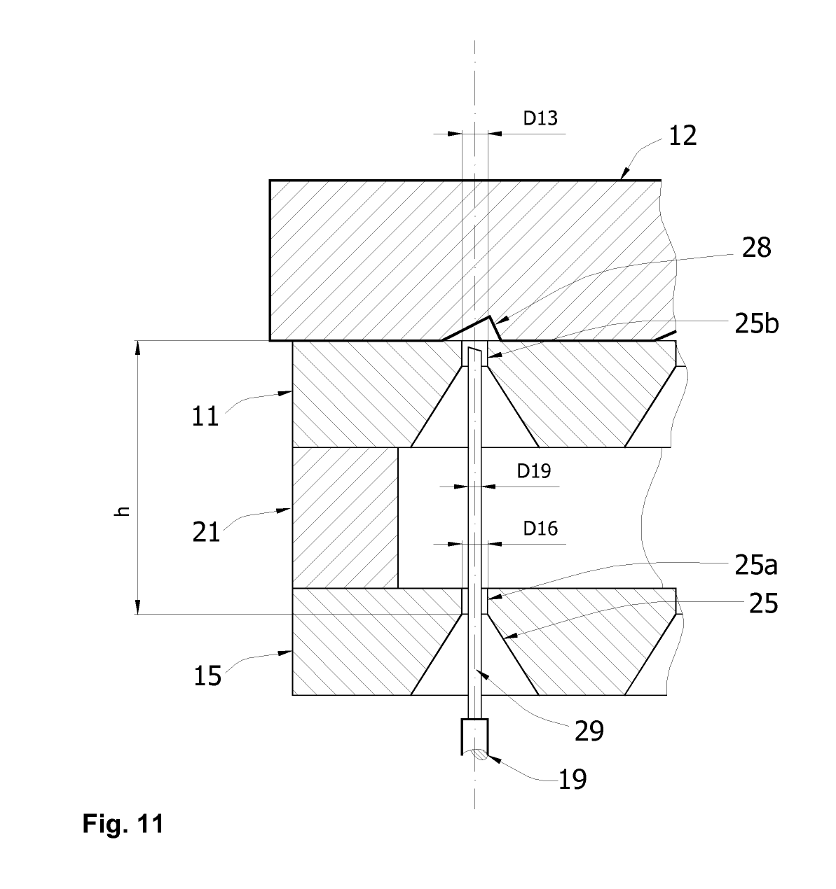

It will be noted, furthermore, that, owing to the spacer 21, the alignment of the optical fibre 19 with reference to the normal N to the sheet 12 is considerably improved. Reference is made in this regard to FIG. 11 which shows an optical fibre 19 in its recess 25. The spacer 21 does not introduce an additional error in the lateral dimensions and in particular in the diameters of the portions 13a and 16a of the holes 13 and 16. It increases, on the other hand, the useful height H of the recess 25 by its own height L. For a useful height H of recess 25 of 2.675 millimetres, the positioning error relative to the normal N to the sheet 12 is now of the order of 0.03°, i.e. a gain in precision by a factor of 3 relative to the first embodiment of the coupling device and by a factor of 45 relative to the prior art!

A coupling device 1, 2 has thus been described, the performance levels of which are improved relative to a conventional coupling device. Of course, the coupling device according to the invention is not limited to the embodiments which have just been described and a broad range of simple modifications and variants may be conceived of by the person skilled in the art without departing from the scope of the invention as defined by the appended claims.

It will be noted, in particular, that in the embodiments presented the optical fibres are introduced bare into the recesses 18 and 25 or protected by a ferrule. In a variant, the fibre could be equipped with a connector at its end. In this case, the end of the connector would be mounted in the coupling device instead of the end of the optical fibre. For this variant, the size of the holes 13 and 16 would have to be adapted to the diameter of the end of the connector as illustrated in FIG. 10.

1. A coupling device for optical fibres comprising:
a first sheet defining a first plurality of through-holes, each of said first plurality of through-holes having at least a portion, with a diameter configured to be approximately a diameter of an optical fibre,
a second sheet joined to said first sheet by a face thereof, and
a third sheet, joined to said first sheet, and defining a second plurality of through-holes, each of said second plurality of through-holes having at least a portion with a diameter configured to be approximately the diameter of said optical fibre, said second plurality of through-holes aligned relative to the first plurality of holes of said first sheet, so as to form a plurality of recesses within each of which one of a plurality of said optical fibres is disposed.

2. The coupling device according to claim 1, wherein said first and third sheets are joined by a respective face.

3. The coupling device according to claim 1 or 2, characterised in that said optical fibres are fixed in said recesses with the aid of an optical glue filling up the residual space around the optical fibres in said recesses.

4. The coupling device according to claim 1, further comprising a spacer, arranged integrally between the first and third sheets, so as to hold them apart and parallel to one another, said plurality of recesses then comprising an initial section and a terminal section set apart from each other by a height of said spacer.

5. The coupling device according to claim 4, wherein said spacer forms a closed volume with the first and third sheets.

6. The coupling device according to claim 4 wherein each of said plurality of optical fibres are fixed in said plurality of recesses with a dose of glue disposed in said initial section and in that said closed volume is filled with an optical gel having an index of refraction close to that of the core of the optical fibre.

7. The coupling device according to claim 4, wherein said spacer is formed by a cylinder portion equipped with an upper face and with a lower face, the upper and lower faces being parallel and tightly attached to the first sheet and to the third sheet respectively.

8. The coupling device according to claim 4, wherein each of said optical fibres are fixed in a respective one of said plurality of recesses with a dose of glue injected into said initial section so as to form, with said optical fibre, a tight-fitting stopper in the initial section and in that said closed volume is filled with an optical oil having an index of refraction close to that of the core of the optical fibre, and further comprising a gas bubble in the optical oil to absorb any thermal expansion of the optical oil.

9. The coupling device according to claim 1, wherein said plurality of holes are formed by photolithography processes and reactive ion etching.

10. The coupling device according to claim 1, wherein said first and third sheets comprise alignment structures produced concomitantly with said holes by photolithography processes and reactive ion etching.

11. The coupling device according to claim 10, wherein said first and third sheets are mounted in a frame equipped with reference surfaces for said alignment structures.

12. The coupling device according to claim 1, wherein at least a portion of said plurality of optical fibres disposed within said plurality of rececesses is bare.

13. The coupling device according to claim 1, wherein at least a portion of said plurality of optical fibres are covered by a tube to mechanically protect each of the plurality of optical fibres.

14. A method of forming a coupling device for optical fibres comprising:
forming a first sheet with a first plurality of through-holes, each of said first plurality of through-holes having at least a portion with a diameter configured to be approximately a diameter of an optical fibre;
forming a second sheet;
joining said second sheet to said first sheet by a face thereof;
forming a third sheet with a second plurality of through-holes, each of said second plurality of through-holes having at least a portion with a diameter configured to be approximately the diameter of said optical fibre;
aligning said second plurality of through-holes relative to the first plurality of holes of said first sheet, so as to form a plurality of recesses within each of which one of a plurality of said optical fibres can be disposed; and
joining said third sheet to said first sheet.

15. The method of claim 14, further comprising forming the first and second plurality of holes by photolithography processes and reactive ion etching.

16. The method of claim 14, further comprising forming alignment structures on said first and third sheets concomitantly with said first and second plurality of holes by the photolithography processes and reactive ion etching.
